(19) United States
(12) Patent Application Publication
(10) Pub. No.: US 2004/0062616 A1
(43) Pub. Date: Apr. 1, 2004

(54) System and method for mounting a bearing and cutting tool on a drive shaft

(75) Inventor: Piergiorgio Pozzo, Udine (IT)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: Freud TMM, Inc., High Point, NC (US)

(21) Appl. No.: 10/260,999

(22) Filed: Sep. 30, 2002

(51) Int. Cl. B23C 5/16

(52) U.S. Cl. 407/53

(57) ABSTRACT

A system for mounting bearing and a router bit on the end of a drive shaft. The drive shaft includes and expandable end portion onto which the bearing member is mounted by an attachment element that is inserted substantially with the expandable end portion to cause sufficient expansion thereof to mount and retain the bearing member in place on the drive shaft.

### BACKGROUND OF THE INVENTION

The present invention relates generally to a system and method for mounting a cutting tool and bearing on the end of a drive shaft. More particularly, this invention relates to a system and method for mounting a router bit and a bearing on the end of a drive shaft.

In general, there are two types of router bits used for cutting or routing wood. Non-pilot bits include a cutting tool or bit mounted directly on the end of a drive shaft for rotation therewith, and they are usually used in conjunction with a fence or jig of some sort to control their cutting paths. Pilot bits, on the other hand, also have a bit mounted on the end of a drive shaft for rotation, and, in addition, a bearing element, such as a ball bearing unit, is mounted on the end of the drive shaft axially beyond the bit. Pilot bits are used for a variety of woodworking projects, and they are most commonly used to rout or cut a profile on the edge of a workpiece or as a flush trim bit.

The bearing unit, which is rotatable relative to the drive shaft and the bit, rides along the edge of a board or a template to keep the bit a fixed distance from the edge to thereby control the cut. Different sized bearings can be used to achieve different depths of cuts.

In conventional pilot bits, the bit is fixed to the drive shaft, and the end portion of the drive shaft extends axially beyond the top of the bit. A bearing, usually a ball bearing, has a central opening that slides over the extending end of the drive shaft to be rotatable relative to the drive shaft. The bearing is held in place by the head of a screw or pin that is screwed into the end of the drive shaft and overlaps the top surface of the bearing to hold it in place on the drive shaft. In some cases a washer is mounted on the drive shaft between the top of the bit and the bearing.

As noted above, a pilot bit is usually used to cut a profile at the edge a workpiece. Sometimes, the depth and configuration of the desired profile are such that the bit cannot reach a proper depth relative to the workpiece, and it is not possible to obtain the desired profile with the bit. More specifically, because the head of the attachment screw must be large enough and strong enough to hold the bearing unit in place, it inherently projects axially beyond the outside surface of the bearing. Accordingly, the projecting screw head will strike a surface below the bearing before the bearing will, and it will therefore prevent the entire rotating bit unit from cutting the profile at a lower position that would otherwise create a deeper cut for the bit.

The present invention provides an arrangement that overcomes this drawback of known router bits and the like.

### SUMMARY OF THE INVENTION

In accordance with the present invention, a system is provided for mounting a bearing and a cutting tool on the end of a drive shaft. The system includes a drive shaft formed with an expandable end portion having an axially extending opening therein with a first diameter, and a cutting tool mounted on the drive shaft with at least part of the expandable end portion extending axially beyond the cutting tool. A bearing member is mounted on the expandable end portion of the drive shaft so that the expandable end portion is disposed substantially within the confines of the bearing member. The attachment element is inserted substantially entirely within the axially extending opening of the end portion of the drive shaft, and the attachment element has a second diameter which is larger than the first diameter of the end portion opening by an amount to cause sufficient expansion of the end portion to mount and retain the bearing in place on the drive shaft.

In the preferred embodiment of the present invention, a washer element may be mounted on the drive shaft between the cutting tool and the bearing member.

It is also preferred that the outside end face of the bearing member be substantially flat, and that the opening in the end portion of the shaft be threaded. The attachment element may be a flat headed screw threadably received in the opening of the end portion with the flat head of the screw being substantially coplanar with the outside end face of the bearing member.

Further, it is preferred that the expandable end portion of the drive shaft include two axially extending slots arranged to render the end portion expandable.

The present invention also includes a method of mounting a bearing and a cutting tool on the end of a drive shaft, such method including the steps of (a) providing a drive shaft with an opening and an expandable end portion; (b) sliding a cutting tool onto the drive shaft and positioning the cutting tool on the drive shaft with the expandable end portion of the drive shaft extending axially beyond the cutting tool; (c) sliding a bearing member onto the drive shaft and positioning the bearing member adjacent the cutting tool and with the expandable end portion of the drive shaft disposed substantially entirely within the confines of the bearing member; and (d) inserting an attachment element into the opening in the end portion of the drive shaft to cause sufficient expansion thereof to mount and retain the bearing member on the drive shaft with the attachment member being disposed substantially entirely within the opening.

Preferably, this method also includes the step of sliding a washer element onto the drive shaft after sliding the cutting tool on the drive shaft and before sliding the bearing member on the drive shaft so that the washer element is captured between the cutting tool and the bearing member when the attachment is inserted into the opening of the drive shaft end portion.

Also, the opening in the end portion of the shaft may be threaded, and the attachment element may be a threaded screw with a flat head. The step of inserting the attachment element may include screwing the attachment element into the opening in the end portion of the shaft until it is substantially entirely within the confines of the opening with the flat head of the attachment element disposed substantially coplanar with the axially outermost surface of the bearing member.

### BRIEF DESCRIPTION OF THE DRAWINGS

FIG. 1 is a perspective view of a preferred embodiment of the cutting tool system of the present invention;

FIG. 2 is an exploded view of the components of the system illustrated in FIG. 1;

FIG. 3 is a diagrammatic view of typical cutting tool system according to the prior art; and

FIG. 4 is a diagrammatic view of the cutting tool system of the present invention illustrated in side-by-side relation with the prior art system illustrated in FIG. 3.

### DETAILED DESCRIPTION OF THE PREFERRED EMBODIMENT

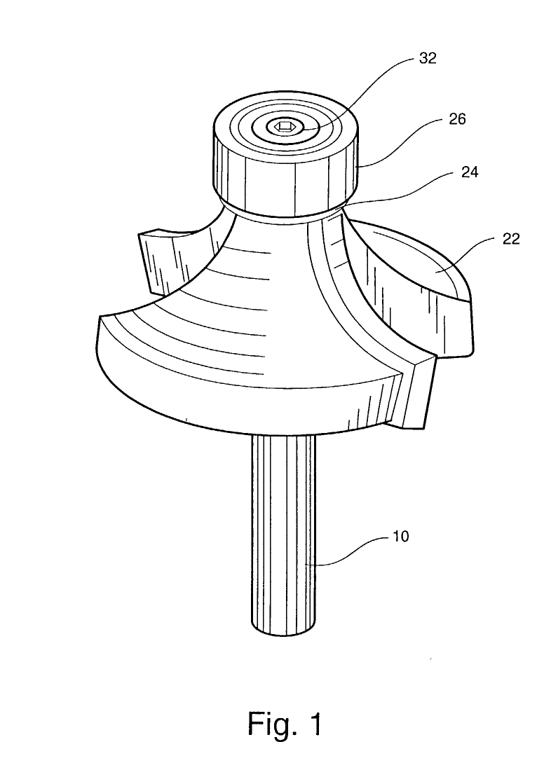

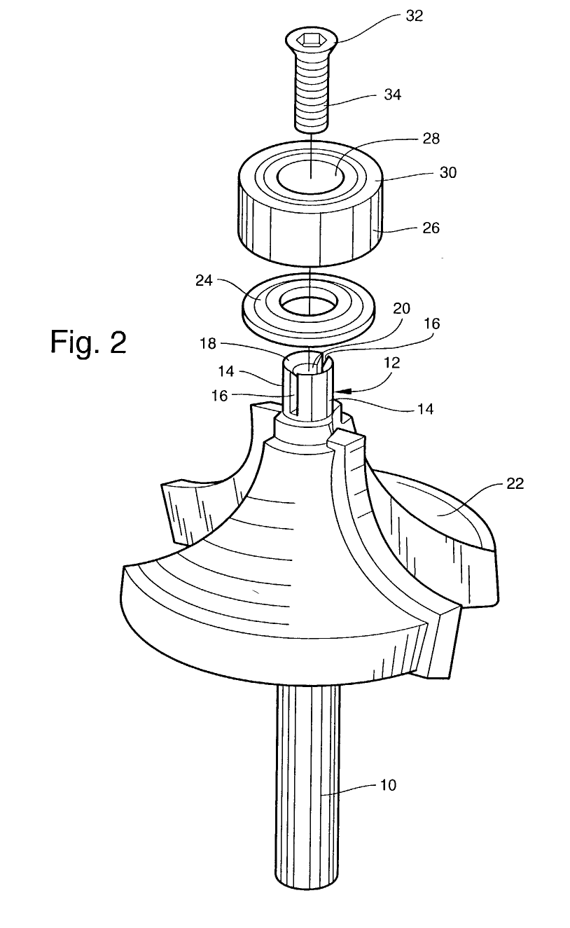

Looking now in greater detail at the accompanying drawings, FIGS. 1 and 2 illustrate a preferred embodiment of the system of the present invention. This system includes a drive shaft 10 that is formed with an expandable end portion 12. This end portion 12 is preferably formed with two essentially semi-circular portions 14 separated by two axially extending slots 16. The end face 18 of the drive shaft end portion 12 has a concave configuration for a purpose to be described in greater detail below, and the center 20 of the end portion 12 is a threaded opening between the semi-circular portions 14.

A cutting tool 22, which in the preferred embodiment of the present invention is a router bit, is mounted on the drive shaft 10 with at least part of the semi-circular portions 14 extending actually beyond the router bit 22 as best seen in FIG. 2.

The system of the present invention may also include a washer element 24 mounted on the end portion 12 of the drive shaft outwardly of the router bit 22. A bearing member 26, which is preferably a ball bearing member, is provided with a center opening 28 and the outside end face 30 of the bearing member 26 is substantially flat. The bearing member 26 is dimensioned so that when the end portion 12 of the drive shaft 10 is received in the center opening 28 of the bearing member 26, the end portion 12 is disposed substantially within the confines of the bearing member 26.

Finally, an attachment element 32 is provided to lock the router bit 22, the washer element 24, and the bearing member 26 in place on the drive shaft 10. The attachment element 32 is preferably a conventional flat-headed screw having a tapered head portion and having a threaded portion 34.

The bearing member 26 and the router bit 22 are mounted on the drive shaft 10 in the following manner. The router bit 22 is slid onto the drive shaft 10 and it is positioned on the drive shaft 10 with the end portion 12 extending axially beyond the router bit 22 as illustrated in FIG. 2. Next, the washer element 24 is also slid onto the end portion 12 of the drive shaft 10 until it is in abutment with the upper face of the router bit 22. The bearing member 26 is then slid onto the drive shaft 10 until it is in abutment with the washer element 24, and in this position of the bearing member 22 the end portion 12 of the drive shaft 10 is disposed substantially within the confines of the bearing member 26. Finally, the flat-headed screw 32 is threaded into the threaded center portion 20 of the end portion 12 until tapered head portion is in abutment with the concave configuration of the end face 18 of the drive shaft 10, and the flat top surface of the screw 32 is substantially coplanar with the flat outside end face 30 of the bearing member 26 as best illustrated in FIG. 1. The semi-circular portions 14 of the end portion 12 are formed so that the center threaded portion 20 has a diameter that is slightly less than the diameter of the threaded portion 34 of the screw 32. Accordingly, when the screw 32 is threaded into the end portion 12, the semi-circular portions 14 are caused to expand sufficiently to mount and retain the bearing member 36 on the end portion 12 of the drive shaft.

Accordingly, after the screw 32 has been threaded into the end portion 12, the system of the present invention is configured as illustrated in FIG. 1 with the bearing member 26 positioned on the end portion 12 of the drive shaft 10 with such end portion 12 substantially fully within the confines of the center opening 28 of the bearing member 26, and the top flat-head of the screw 32 is positioned so that it is substantially coplanar with the outside end face 30 of the bearing member 26. In the preferred embodiment of the present invention, the washer element 24 is captured or sandwiched between the top of the router bit 22 and the bearing member 26 which is frictionally held in place by the expanded end portion 12. However, in some applications of the system of the present invention, the washer element will not be necessary and it can be omitted entirely. Also, it is to be understood that while the attachment element 32 is preferably a flat-headed screw, it can take the form of any equivalent attachment member that will create the necessary expansion of the end portion 12 of the drive shaft 10 to frictionally hold the bearing member 36 securely in place on the end portion 12 of the drive shaft 10.

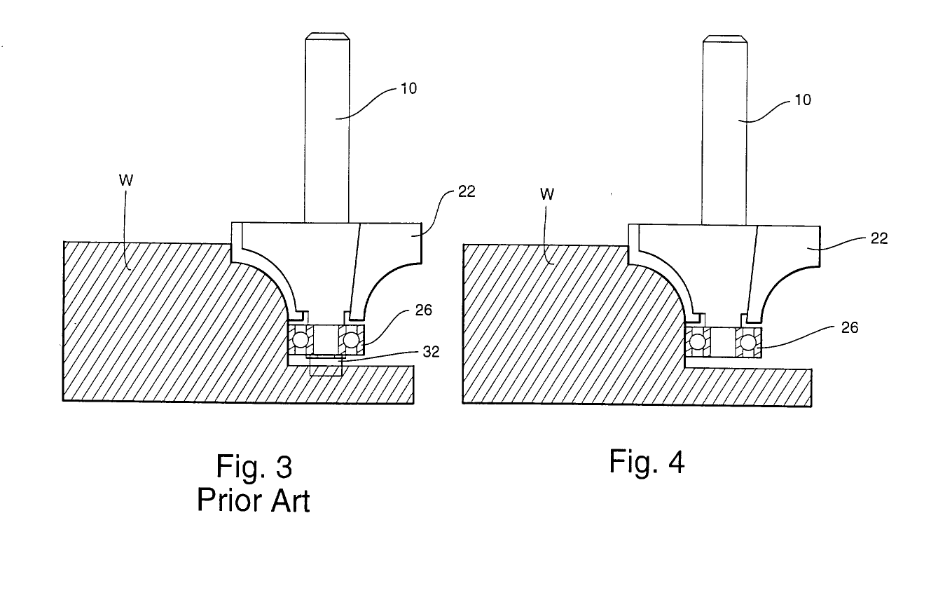

One significant advantage of the present invention is illustrated in the comparison of FIG. 3, which illustrates diagrammatically a conventional router bit mounting system, and FIG. 4 which illustrates diagrammatically the mounting system of the present invention. As discussed in greater detail above, the conventional router bit mounting system illustrated in FIG. 3 includes an attachment number 32 in the form of a screw having a wide head that overlaps the bottom surface of the bearing member 26 to hold it in place on the drive shaft 10, and the head portion of the attachment element 32 extends vertically well below the flat bottom surface of the bearing member 26. Accordingly, when the router bit 22 is used to cut a typical profile in the of end of a piece of wood W, the outwardly extending head of the attachment screw 32 will not permit the router bit 22 to move downwardly to the extent necessary to cut the desired profile because it will come into abutment with the flat bottom surface of the profile. In FIG. 3, for illustration purposes only, the vertical extent of the head of the attachment screw 32 is shown beneath the flat surface of the wood just to illustrate the problem presented by the vertical extent of the head of the attachment screw 32. In fact, the head of the screw would stop when it comes into abutment with the flat surface of the wood piece, and it would not thereafter be possible to move the router bit 22 downwardly further to form the desired profile.

By contrast, looking at FIG. 4, since the attachment element is fully contained within the confines of the bearing member 26 as described in detail above, there is nothing to interfere with the movement of the router bit 22 downwardly to form the desired profile in the end face of the wood W.

While the comparison illustrated in FIGS. 3 and 4 demonstrates one of the substantial advantages offered by the mounting system of the present invention, it will be understood that this comparison is illustrative of only one of a wide variety of profiles that can be readily cut by a cutting tool mounted on a drive shaft using the mounting system of the present invention that would not be feasible with conventional mounting systems as illustrated in FIG. 3.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

1. A system for mounting a bearing and a cutting tool on the end of a drive shaft that includes:
(a) a drive shaft formed with an expandable end portion having an axially extending opening therein with a first diameter;
(b) a cutting tool mounted on said drive shaft with at least part of said expandable end portion extending axially beyond said cutting tool;
(c) a bearing member mounted on said expandable end portion of said drive shaft so that said expandable end portion is disposed substantially within the confines of said bearing member; and
(d) an attachment element inserted substantially entirely within said axially extending opening of said end portion of said drive shaft, said attachment element having a second diameter which is larger than said first diameter of said end portion opening by an amount to cause sufficient expansion of said end portion to mount and retain said bearing member in place on said drive shaft.

2. A system for mounting a bearing and a cutting tool on the end of a drive shaft as defined in claim 1, wherein said system includes a washer element mounted on said drive shaft between said cutting tool and said bearing member.

3. A system for mounting a bearing and a cutting tool on the end of a drive shaft as defined in claim 1, wherein the outside end face of said bearing member is substantially flat, wherein said opening in said end portion of said shaft is threaded, and wherein said attachment element is a flat headed screw threadably received in said opening of said end portion with the flat head of said screw being substantially coplanar with said outside end face of said bearing member.

4. A system for mounting a bearing and a cutting tool on the end of a drive shaft wherein said expandable end portion of said drive shaft includes two axially extending slots arranged to render said end portion expandable.

5. A system for mounting a bearing and a router bit cutting tool on the end of a drive shaft that includes:
(a) a drive shaft formed with an expandable end portion having an axially extending threaded opening therein with a first diameter and two axially extending slots that intersect with said opening;
(b) a router bit cutting tool mounted on said drive shaft with at least part of said expandable end portion extending axially beyond said router bit cutting tool;
(c) a bearing member mounted on said expandable end portion of said drive shaft so that said expandable end portion is disposed substantially within the confines of said bearing member, said bearing member having an outside end face that is substantially flat; and
(d) a flat headed screw having a threaded portion inserted entirely within said axially extending opening of said end portion of said drive shaft with said flat head of said screw being disposed substantially coplanar with said flat end face of said bearing member, said threaded portion having a second diameter which is larger than said first diameter of said end portion opening by an amount to cause sufficient expansion of said end portion to mount and retain said bearing in place on said drive shaft.

6. A method of mounting a bearing and a cutting tool on the end of a drive shaft that includes the steps of:
(a) providing a drive shaft with an opening and an expandable end portion;
(b) sliding a cutting tool onto said drive shaft and positioning said cutting tool on the drive shaft with said expandable end portion of said drive shaft extending axially beyond said cutting tool;
(c) sliding a bearing member onto said drive shaft and positioning said bearing member adjacent said cutting tool and with said expandable end portion of said drive shaft disposed substantially entirely within the confines of said bearing member; and
(d) inserting an attachment element into said opening in said end portion of said drive shaft to cause sufficient expansion thereof to mount and retain said bearing member on said drive shaft with said attachment member being disposed substantially entirely within said opening.

7. A method of mounting a bearing and a cutting tool on the end of a drive shaft as defined in claim 6, wherein said method also includes the step of sliding a washer element onto said drive shaft after sliding said cutting tool on said drive shaft and before sliding said bearing member on said drive shaft so that said washer element is captured between said cutting tool and said bearing member when said attachment is inserted into said opening of said drive shaft end portion.

8. A method of mounting a bearing and a cutting tool on the end of a drive shaft as defined in claim 6, wherein said opening in said end portion of said shaft is threaded, wherein said attachment element is a threaded screw with a flat head, and wherein said step of inserting said attachment element includes screwing said attachment element into said opening in said end portion of said shaft until it is substantially entirely within the confines of said opening with said flat head of said attachment element disposed substantially coplanar with the axially outermost surface of said bearing member.
